(19) United States
(12) Patent Application Publication
(10) Pub. No.: US 2009/0115598 A1
(43) Pub. Date: May 7, 2009

(54) APPARATUS AND METHOD FOR STIMULATING SCHEDULED USE OF A CONSUMABLE SUBSTANCE

(75) Inventor: Thomas H. Carlson, JR., Vancouver, WA (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: Thomas H. Carslon, JR., Vancouver, WA (US)

(21) Appl. No.: 11/936,692

(22) Filed: Nov. 7, 2007

(51) Int. Cl. G08B 21/24

(52) U.S. Cl. 340/526

(57) ABSTRACT

A device for stimulating scheduled use of a consumable substance. The device includes a sensor and an indicator, the indicator having a state which is dependent upon time elapsed since occurrence of a consumption event detected by the sensor.

### BACKGROUND AND SUMMARY

The present description relates generally to containers and to systems and methods for facilitating a recommended or desired use of the container, for example to increase the likelihood that a substance stored in the container will be consumed or used according to a schedule. The present description is applicable to food products, medications and a wide variety of other consumable substances and the containers in which those substances are stored.

Tasks such as taking vitamins and medication, feeding pets, and drinking enough fluids, are activities that people often wish to do on a periodic basis, but often forget to do, or forget that they have already done them, during the course of their day.

There exist special timers that people can buy that give an audible alarm when the time to take medication has arrived. Some devices incorporate this timer into a container. Major shortcomings of these containers with built in timers, are attributed to their complexity. They are expensive and difficult to use, due to the complexity of their interface. Typically, many buttons and even a display are present on such devices to allow the user to set the time between doses and tell the user how long till the next dose. These buttons and displays cause these devices to be expensive, which limits their use. They also cause these devices to be relatively complicated to use, which limits their use to only those people of relatively high cognitive, visual, and physical ability.

The present invention allows a larger user population to benefit by minimizing and sometimes eliminating the user interaction with the device. Users with limited visual ability, users with limited dexterity, and users with reduced cognitive ability all benefit from reducing the required user interaction necessary.

The present invention allows significant manufacturing cost reductions by limiting the complexity of the device, thus making the device inexpensive enough that multiple devices may be used in a single household, on multiple containers, allowing the user to keep track of a large number of repetitive events such as different vitamins, different medications, and different pet foods, in an intuitive and low cost manner.

### BRIEF DESCRIPTION OF THE FIGURES

The above features and advantages will be readily apparent from the following detailed description of example embodiment(s). Further, these features and advantages will also be apparent from the following drawings.

FIG. 1 is an exemplary embodiment of a containment system including a reminder device for storing consumable substance and prompting a user to execute a task associated with the consumable substance according to a schedule.

FIG. 2 is a schematic representation of power and signal connections for an exemplary embodiment of a reminder device.

FIG. 3 is an exemplary state diagram for firmware residing in a control process unit of a reminder device for operation in a reminder mode.

FIG. 4 is an exemplary state diagram for firmware residing in a control process unit of a reminder device for operation in a tamper mode.

### DETAILED DESCRIPTION OF EXAMPLE EMBODIMENT(S) OF THE INVENTION

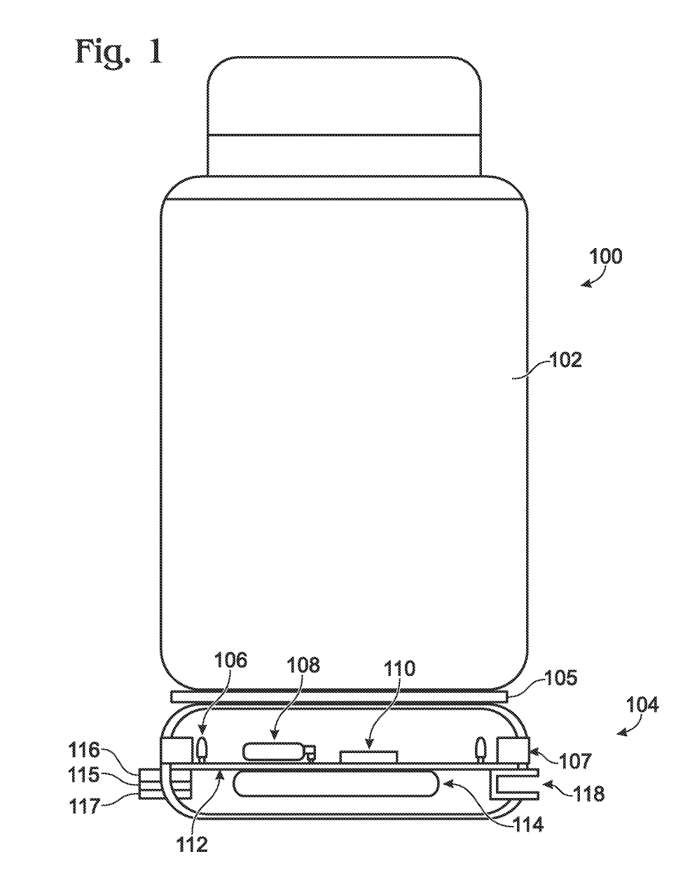

FIG. 1 shows a view of an exemplary embodiment of a system for stimulating scheduled use of a consumable substance, such as medication, food products, pet food and the like. The system may be implemented in various ways, however the examples discussed herein will primarily focus on with containers used to store and dispense consumable substances. For example, various embodiments discussed herein may be employed to great advantage on medication vials and containers to ensure medications are taken in proper dosages at appropriate times.

In one example embodiment, a timer and sensor are incorporated into a portion of a storage/dispensing container. For example, these components may be provided in a container lid or cap, such as the top of a prescription medication vial. The sensor is adapted to detect consumption events, which may include disturbance or other movements of the vial, removal and/or reattachment of the lid to the vial, etc. In any case, the consumption events are selected to correlate with periodic uses of the consumable substance. For example, when prescription tablets are taken by a patient, the patient picks up the bottle (i.e., disturbs or moves the bottle), removes the cap to dispense the tablet(s) and re-attaches the top to close the vial. The sensor, which may be a motion sensor, is adapted to detect these events. The system infers that when such a consumption event has been detected, that the user has used the substance (e.g., taken a prescribed dose of medication). This causes the timer to be reset. The timer continues to run, and after a selected time interval, the indicator changes state (lights up, beeps, vibrates, etc.) to indicate that another use/dose is permitted, suggested, required, etc. The timer, sensor and indicator thus cooperate to prompt the user to use the consumable substance according to a desired schedule.

In many implementations, it will be desirable to simplify the device and system to the greatest extent possible. As such, in some implementations, the system will be pre-configured during manufacture to operate on common time intervals that cannot be modified after purchase. For example, to aid in reminding a patient to take a medication four times a day, a system with a preset six-hour interval may be provided. Other implementations may allow for user programmability or adjustment to provide more flexibility and/or meet specific needs. As described in detail below, embodiments may also be provided which allow for operation in multiple different modes. Consumables suitable for use with the system include without limitation prescription medications, vitamins, fish food, or fluids.

Returning specifically to the example of FIG. 1, the depicted embodiment shows a container 100 for storing and dispensing consumable substances, and a reminder device 104 for tracking and indicating time-related conditions to facilitate use/consumption in accordance with a desired schedule. Reminder device 104 may be mounted to various components of the containment system 100. Such storage components may include a vessel 102 with a closure cap, such as a prescription vial. The reminder device 104 may be mounted to the storage components with an adhesive 105, although reminder device 104 may be mounted to the storage components with any suitable coupling mechanism. Alternately, reminder device 104 may be integrated into the storage components, for example in the closure cap.

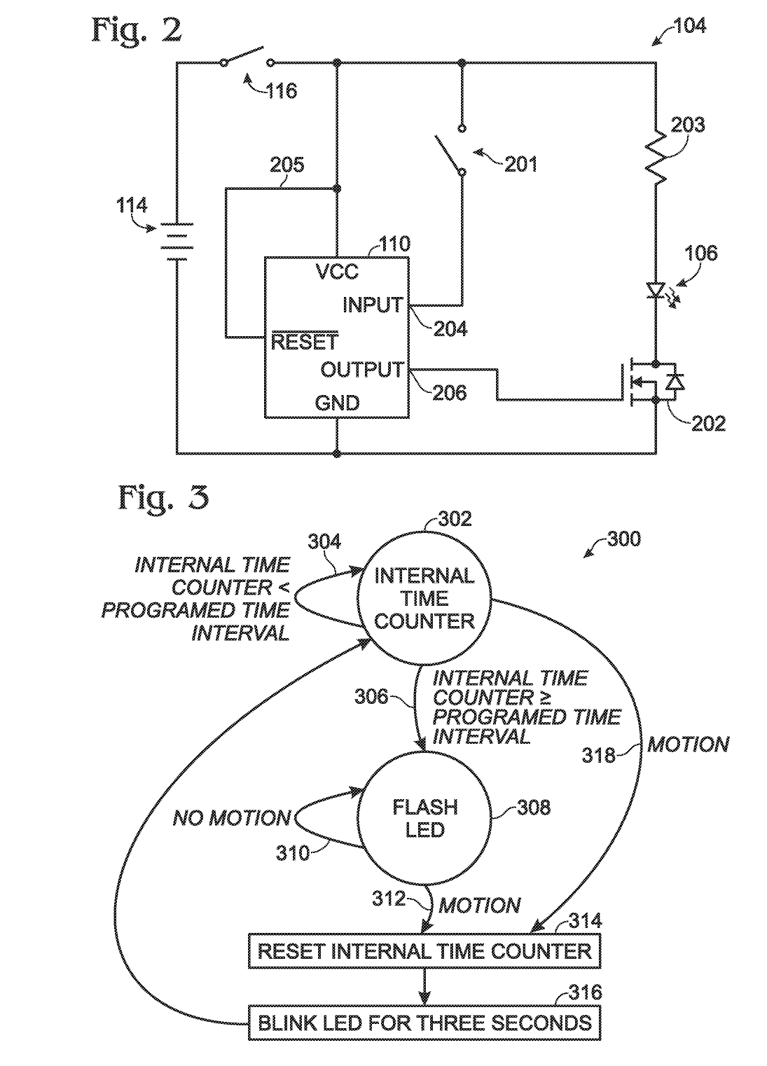

Reminder device 104 may include various components operable to indicate time-oriented conditions of the stored medication based on the prescribed schedule of the medication. In particular, a sensor for detecting a consumption event and an indicator for displaying a signal may be included in container 100 to facilitate implementation of the prescribed schedule. In the embodiment described herein, the indicator may be a light emitting diode (LED) 106 configured to emit light through a light pipe 107, and the sensor may be motion sensor 108 configured to detect a consumption event based on motion, as described in greater detail in FIG. 2. LED 106 may be selectively configured in one or more states to display a visual signal. For example, LED 106 may be configured to selectively emit a steady light or flash based on the time-oriented condition. Motion sensor 108 may be configured to detect a consumption event based on motion and is described in greater detail in FIG. 2. Under some conditions, LED 106 may be configured in a state based on a consumption event detected by the motion sensor 108. This feature may be described in greater detail below.

It may be appreciated that various other indicators and/or sensors may be used in the system described herein. Other suitable indicators for displaying a signal may include visual, audio, and sensory indicators that may be selectively configured in one or more states to display a signal. Further, some sensors may be used to detect a consumption event based on other detectable conditions, such as detected reductions in mass, spatial displacements, and/or applied pressure on the closure cap.

Additional components may be included in reminder device 104 to provide other features. In one example, a power switch 116 may be configured to receive user input so as to deactivate reminder device 104 during travel or shipping, for example. In another example, a mode switch 117 may be configured in multiple positions to operate the reminder device 104 in various modes, as described in further detail below. In yet another example, a manual reset button 115 may be configured to reset reminder device 104, as described further below. In yet even another example, the prescribed schedule may be received through a schedule interface, such as a port 118 or one or more manual input buttons (not shown), alternately or in addition to a preprogrammed schedule.

The prescribed schedule described herein includes a timetable of designated consumption events for the stored medication, such as a consumption frequency recommended in a prescription. In one embodiment, the recommended consumption frequency may include a time interval for consuming the stored medication. For example, the prescription may recommend consuming a medication every 24 hours. As described above, the prescribed schedule including designated consumption events at 24-hour intervals may be received at port 118. Alternately, the prescribed schedule may be preprogrammed for reminder device 104 such that a user may generally use reminder device 104 for consumables with desired consumption events every 24 hours. As such, visual indicia associated with the preprogrammed time interval may be exhibited on reminder device 104. For example, a label indicating the consumption frequency for the stored medication may be affixed to reminder device 104. In another example, reminder device 104 may include a color for identifying the preprogrammed time interval (e.g., a red reminder device is used for medications taken every 12 hours, a blue reminder device is used for medications taken every 24 hours, etc.).

Other components of the system may facilitate operation of reminder device 104. A controller 110 to store and/or execute instructions described herein. In addition, the controller may include a timer for determining an elapsed time. Controller may be implemented in a printed circuit board 112 or other appropriate design. Reminder device 104 may also include a coin cell battery 114 configured to deliver power to the system based on the requirements of the components, although any suitable power source may be used.

Controller 110 may execute instructions in accordance with a mode of operation. Specifically, the controller may receive feedback from the components described herein and selectively prompt one or more components based on the feedback and instructions stored in reminder device 104. As such, interaction amongst the components of reminder device 104 may be demonstrated in an electrical schematic diagram including power and signal connections.

FIG. 2 is a schematic representation of an exemplary embodiment of the reminder device 104 illustrating power and signal connections implemented in the methods described herein. In particular, reminder device 104 is schematically illustrated to include power and signal connections between LED 106, a motion switch 201, controller 110, coin cell battery 114, and power switch 116. Such connections may be directed via a transistor 202 configured to switch the flow of current through LED 106 or through controller 110 based on the configuration of motion switch 201 and power switch 116.

Controller 110 may be configured to regulate a power connection between coin cell battery 114 and LED 106. For example, controller 110 may prompt power delivery from coin cell battery 114 through a resistive element of LED 106 so as to emit light from LED 106. The current exiting LED 106 may be directed through the transistor 202 to a terminal of coin cell battery 114. However, the power connection between coin cell battery 114 and LED 106 may be interrupted when power switch 116 is open. For example, reminder device 104 may be selectively deactivated during travel or shipping via user input at an external portion of power switch 116 and later reactivated for use accordingly. It may be desirable to re-synchronize reminder device 104 following such a deactivation. In one example, re-synchronizing reminder device 104 may include resetting the internal timer of controller 110. Accordingly, a reset loop 205 coupled to controller 110 may provide a connection for a reset of the internal timer based on programmed instructions. Alternately, controller 110 may prompt a reset of the timer through the reset loop via user input at an external portion of reset button 115.

Motion switch 201 may be configured to facilitate a signal connection when the reminder device 104 is activated. In particular, motion switch 201 may at least temporarily close upon motion of reminder device 104, such as during a consumption event. At this time, a pulse of current may directed through the closed motion switch and received at input 204 of controller 110. As follows, the controller 110, upon direction of it's internal timers and algorithms, may alter output 206 to control transistor 202 and thus actuate LED 106. The power of the system being supplied by coin cell battery 114.

Controller 110 may execute instructions according to the methods described herein in response to receiving a pulse through motion switch 201. In particular, controller 110 may execute instructions in response to the pulse in accordance with a mode of operation received at mode switch 117. In a first embodiment, controller 110 may operate in a reminder mode to reset the internal timer in response to the pulse. In a second embodiment, controller 110 may operate in a tamper mode to track motion, as described in further detail below.

It may be appreciated that a consumption event as described herein may be determined when controller 110 receives a pulse as a result of motion switch 201 at least temporarily closing or when controller 110 receives a reset request based on user input at manual reset button 115 based on a mode of operation of reminder device 104. In a reminder mode, a consumption event may be determined based on motion detected by motion sensor 108. In a tamper mode, a consumption event may be determined based on user input via manual reset button 115. In doing this, controller 110 may execute instructions for a reminder mode position to implement use of the stored medication for a prescription of an intended user and in a tamper mode position to track motion resulting from tampering by potentially unintended users based on a position of mode switch 117.

Referring first to the reminder mode, FIG. 3 shows an exemplary state diagram for the firmware residing in controller 110 of the device for operation in a reminder mode. Generally, reminder device 104 may be configured to indicate a reminder at a designated consumption event time and reset the device to indicate subsequent reminders when a consumption event is determined. Specifically, when operating in the reminder mode, the consumption event described herein may be detected by motion sensor 108 (i.e. when motion switch 201 at least temporarily closes). In doing this, reminder device 104 may be operable to facilitate the implementation of the prescribed schedule at programmed time intervals.

Turning specifically to FIG. 3, state 302 includes an internal timer for counting time. Method 300 continues to count (at 304) while the internal timer is less than the programmed time interval. If the internal timer meets the programmed time, method 300 transitions (at 306) to state 308. State 308 includes flashing the LED 106. As such, the flashing LED may serve to remind the user at a designated consumption event time to consume the prescribed medication. LED 106 may continue to flash while no motion is detected (i.e., at 310). However, if motion is detected (i.e., at 312), method 300 transitions to state 314. State 314 includes resetting the internal timer. Method 300 then continues to state 316. State 316 includes blinking the LED 106 for three seconds, for example. Finally, method 300 may return to state 302 whereby the method may be repeated. In this way, the LED 106 may flash to remind a user of a designated consumption event time until a consumption event is detected by the motion sensor and reset the internal timer when the consumption event is detected.

However, under some conditions, motion may be detected, as at 318, before the programmed time interval. For example, a user may consume the stored prescription before the designated consumption event time without a reminder from the LED 104. As such, the internal timer may be reset at state 314. In doing this, state 308 may be bypassed and the LED 106 may not be activated until a subsequent designated consumption event time. In the same way as described above, method 300 continues to state 316 where the LED 106 blinks for three seconds, and the method may be repeated.

It may be appreciated that the reminder device 104 of FIG. 1 may operate in a reminder mode without the additional components (e.g., the power switch, the mode switch, the manual reset button, etc.) described above to provide design simplicity, for example. However, the reminder device 104 may include such additional components including at least the mode switch 117 and the manual reset button 117 when operation of the reminder device in a tamper mode may be desirable. For example, operation in a tamper mode may allow an intended user to speculate that a child in the household may access dangerous prescription medications at a particular time.

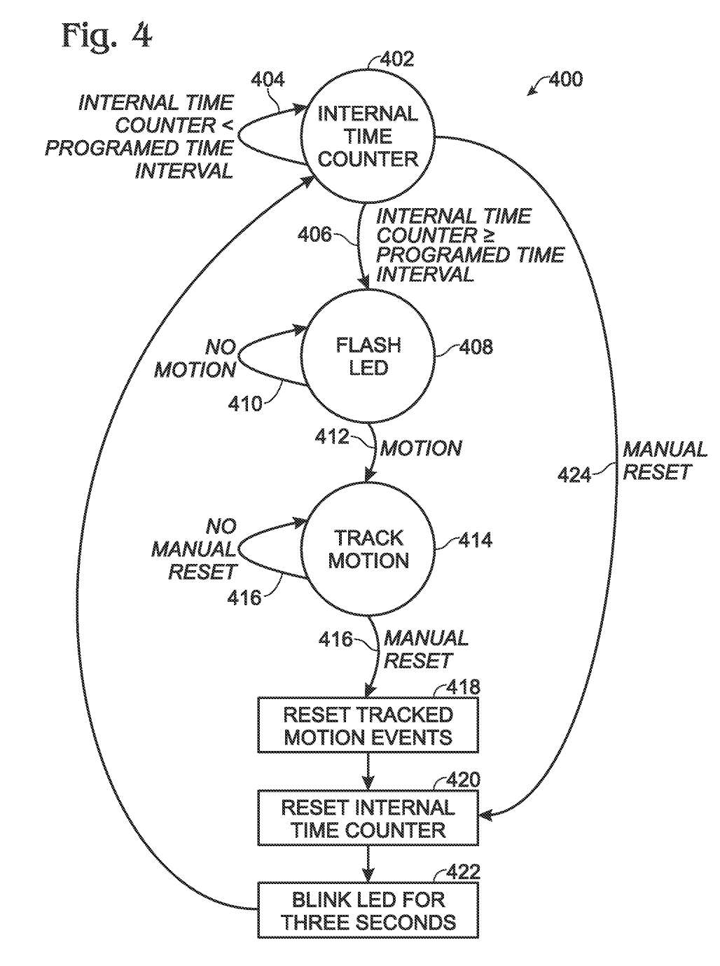

FIG. 4 shows an exemplary state diagram for the firmware residing in controller 110 of the device for operation in a tamper mode. Reminder device 104 may operate in a tamper mode according to method 400 to indicate a reminder for the user at a designated consumption event time as described in FIG. 3 for the reminder mode; however, reminder device 104 may be further operable in a tamper mode including an additional tracking feature to monitor motion of the system. In particular, when operating in a tamper mode, reminder device 104 tracks motion in response to detecting motion via motion switch 201 instead of resetting the internal timer of reminder device 104. Rather, reminder device 104 may be reset via user input at manual reset button 115 when operating in a tamper mode. In doing this, the intended user may view consumption events of the reminder device 104 so as to speculate whether another person may have used the stored contents.

Turning specifically to FIG. 4, reminder device 104 may begin at state 402 continuing through state 408 in the same manner as shown in FIG. 2. That is, state 400 includes an internal timer for counting time (i.e., at 404) while the internal timer is less than the programmed time interval. If, the time counter meets the programmed time interval (at 406) the LED 106 flashes at 408 until motion is detected, as shown at 412.

However, when motion is detected, reminder device 104 operating in a tamper mode tracks the motion. In one example, any indicator, such as LED 106, may be configured to display a signal distinct from the signal for reminding a user of the designated consumption event time.

In another example, a time of any tracked motion may be stored in memory of reminder device 104 at controller 110 and may further be downloaded to a client device at a later time. As such, it may be noted that reminder device 104 operating in a tamper mode may track detected motion events rather than reset the device upon detecting motion as executed in a reminder mode.

Referring back to FIG. 4, method 400 continues to track motion events (at 414) until a manual reset is prompted via user input at the manual reset button, as shown at 416. Continuing with method 400, tracked motion events may be reset at state 418 following a manual reset, as shown at 416. However, if, at 402, a reset is requested via user input at manual reset button 115 before the programmed time interval (as shown at 424), method 400 continues to state 420 thereby bypassing activation of the LED 106 and tracking of motions as described above. Next, method 400 continues to state 420 includes resetting the internal timer. Method 400 then continues to state 422. State 422 includes blinking the LED 106 for three seconds, for example. Finally, method 400 may return to state 402 whereby the method may be repeated. In this way, the reminder device 104 may facilitate execution of tasks by a user according to a schedule and track detected motion of the reminder device 104.

It may be desirable to include various security features at the manual reset button 115 to reduce or prevent unintended users from resetting the tracked times. For example, the manual reset button may include a password. In another example, the manual reset button may be activated based on communication of a client device of the intended user via the port.

It may be appreciated that the order of processing to be detailed is not necessarily required to achieve the features and advantages of the example embodiments described herein, but is provided for ease of illustration and description. One or more of the illustrated steps or functions may be repeatedly performed depending on the particular strategy being used. Further, the described steps may graphically represent code to be programmed into a computer readable storage medium for the sensor, for example, in the engine control system.

In the various container-related examples described herein, it should be appreciated that the described devices and methods may be employed with entire containers, and/or in connection with just a portion of the container. For example, the described systems may be incorporated into vitamin containers by the vitamin manufacturer. For example, the described systems may be incorporated into containers stocked by the pharmacies so pharmacist can dispense the medication to the user directly in said containers. For example, the described systems may be incorporated into container lids or closure caps (e.g., for medication vials) that are sold separately to end-users, so that the caps can be used in place of the original caps provided with a pre-existing container. For example, medication vials with conventional caps may be enhanced through use of an appropriately-configured replacement cap according to the present description. An eight-hour pre-programmed cap could be used for medication prescribed for three dosages a day; a twelve-hour cap for twice daily medication, etc. After a course of medication is completed, the caps could be retained for use with future prescriptions. Furthermore, caps with varying preset time intervals may be packaged together to fit standard-sized containers. In particular, a kit could be provided containing one or more 2× daily caps, one or more 3× daily caps, one or more once a day caps, etc., in various sizes selected to accommodate standard-sized medication containers. Color coding may be used to distinguish different intervals, to further simplify use for the end user.

Furthermore, it will be appreciated that the various embodiments of reminder devices and methods of operating reminder devices disclosed herein are exemplary in nature, and these specific embodiments are not to be considered in a limiting sense, because numerous variations are possible. The subject matter of the present disclosure includes all novel and non-obvious combinations and subcombinations of the various reminder devices, methods of operating reminder devices, and other features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the various features, functions, elements, and/or properties disclosed herein may be claimed through amendment of the present claims or through presentation of new claims in this or a related application. Such claims, whether broader, narrower, equal, or different in scope to the original claims, also are regarded as included within the subject matter of the present disclosure.

We claim:

1. A device for stimulating scheduled use of a consumable substance, comprising:
a sensor;
a timer; and
an indicator operatively coupled with the timer and the sensor, where a state of the indicator is dependent upon time elapsed since occurrence of a consumption event detected by the sensor.

2. The device of claim 1, where the sensor, timer and indicator are incorporated into a cap adapted to be received on an opening of a container so as to close the container.

3. The device of claim 2, where the consumption event detected by the sensor is removal or reattachment of the cap.

4. The device of claim 2, where the device is configured so that the state of the indicator changes after elapse of a time interval.

5. The device of claim 4, where the time interval is pre-determined and set during manufacture of the device.

6. The device of claim 2, where the cap is adapted and sized for use with a pre-existing medication vial, so as to allow end-user replacement of an original cap of the medication vial.

7. The device of claim 1, where the sensor is a motion sensor configured to detect a motion of the device, the sensitivity of the sensor being selected so as to only detect motion of sufficient magnitude to correlate with a consumption event.

8. The device of claim 1, where the sensor is configured to detect a disturbance of the device and cause the timer to reset upon detection of such disturbance.

9. The device of claim 1, where the device is incorporated into at least a portion of a container for storing and dispensing the consumable substance, and where the device is configured so that the state of the indicator changes after elapse of a time interval following the consumption event.

10. The device of claim 9, where the time interval is predetermined and configured during manufacture of the device so as to not require post-purchase programming by a user of the device.

11. The device of claim 9, where the sensor, timer and indicator are incorporated into a lid of the container.

12. The device of claim 1, where the indicator is a light emitting device (LED).

13. The device of claim 1, where the indicator is an audio indicator.

14. A device for stimulating scheduled use of a consumable substance, comprising:
a container lid adapted and sized for use with a pre-existing standard-sized container, so as to replace an original lid of the container;
a sensor incorporated into a body of the container lid and adapted to detect a consumption event; and
an indicator operatively coupled with the sensor, where the indicator is configured so that a state of the indicator is dependent upon a time elapsed since occurrence of the consumption event.

15. The device of claim 14, where the sensor is a motion sensor configured to detect a disturbance of the device and cause the timer to reset upon detection of such disturbance.

16. The device of claim 15, where the sensor is configured to change state after elapse of a time interval which is predetermined and set during manufacture, so as to not require post-purchase programming by a user of the device.

17. The device of claim 16, where the container lid is adapted and sized for use with a pre-existing standard-sized medication vial.

18. The device of claim 16, where the container lid is adapted and sized for use with a pre-existing standard-sized food product container.

19. The device of claim 16, where the indicator is a light emitting device

20. The device of claim 16, where the indicator is an audio indicator.

21. A device for stimulating scheduled use of a consumable substance, comprising:
a portion of a container for storing and dispensing a consumable substance; and
a motion sensor and an indicator incorporated into the portion of the container,
where the motion sensor is configured to detect a consumption event, and where the indicator is configured so that a state of the indicator changes upon elapse of a predetermined time interval following the consumption event, and where the predetermined time interval non-programmable and set during manufacture of the device.

22. The device of claim 21, where the portion of the container is a lid of the container.

23. The device of claim 21, where the consumption event is a disturbance of the container.

24. The device of claim 21, where the consumption event is removal or reattachment of a lid of the container.
